(19) United States
(12) Patent Application Publication
(10) Pub. No.: US 2026/0065020 A1
(43) Pub. Date: Mar. 5, 2026

(54) ATTENTION ASSISTED ARTIFICIAL INTELLIGENCE ARCHITECTURE

(71) Applicant: Aicadium Holdings Pte. Ltd., Singapore (SG)

(72) Inventors: Logan Charles HOLLMER, Nevada City, CA (US); Dimitry FISHER, San Diego, CA (US); Joshua JACOBSON, Ann Arbor, MI (US)

(21) Appl. No.: 19/313,786

(22) Filed: Aug. 28, 2025

Related U.S. Application Data
(60) Provisional application No. 63/688,813, filed on Aug. 29, 2024.

(51) Int. Cl. G06N 3/045; G06N 3/08

(52) U.S. Cl. CPC G06N 3/045; G06N 3/08

(57) ABSTRACT

An apparatus, comprising: a context module to receive data from one or more input sources, to sample the data, and to determine a context of the data; an attention module to receive samples of the data from the context module and determine whether the samples of the data contain information for processing; one or more specialized processing modules to generate processed data from the data based on a determination by the attention module to process the data and to send the processed data to the context module; a decision module to receive the context of the data and the processed data from the context module and determine actions to be executed based on the context of the data and the processed data; and one or more action handlers to execute the actions in response to instructions received from the decision module.

### CROSS-REFERENCE TO RELATED APPLICATIONS

This Application claims the benefit of and priority to U.S. Provisional Patent Application No. 63/688,813 , filed on Aug. 29, 2024, the entire contents of which are hereby incorporated by reference.

### BACKGROUND

### Field

Aspects of the present disclosure relate to artificial intelligence (AI), and in particular, to an AI architecture that facilitates efficient use of computational resources by AI models.

### Description of Related Art

In recent years, software engineers and developers have focused on integrating AI models into traditional software platforms that were designed and implemented long before the advent of AI. For example, many business logic components of traditional business management software platforms have been replaced by AI models. However, in spite of the evolution in computer systems to better handle the computationally demanding workloads of AI models, three problems with integrating AI models into traditional software platforms have emerged.

First, software platforms that incorporate AI models use computational resources, such as processors, memory, and storage, in a manner that is wasteful and unsustainable. For example, many AI models use tens to hundreds of dedicated graphics processing units (GPUs) to handle the enormous parallel processing requirements of AI models. These GPUs often remain dedicated to the AI models even when the AI models are not running. The AI models also use vast amounts of storage and memory. For example, large amounts of local high-speed storage are needed for feeding training data during AI model training. This demand for resources is expensive and can be a limiting factor in deciding whether to deploy these software platforms on premise.

Second, AI models, in general, require retraining and updating to stay relevant, accurate, and adjust to new input data or changes in desired outputs. Generative AI models, for example, exacerbate these problems by requiring long training times and large amounts of training data. Each time a software platform is changed the AI models incorporated in the platform must be retrained, new AI models may be added, and the platform may have to be reconfigured. As a result, updating or changing software platforms that incorporate AI models is challenging, costly, and time-consuming.

Third, incorporating AI models into a software platform creates a tradeoff between speed and accuracy. Typically, to obtain highly accurate results, complex, special purpose AI models are deployed. These complex, special purpose AI models output accurate results. On the other hand, smaller, general purpose AI models are typically much faster than the more complex, special purpose AI models. However, the results obtained tend to be less accurate than would otherwise be obtained with the more complex, special purpose AI models.

Accordingly, improved approaches to use and integrate AI models into systems while prioritizing efficient resource usage and allowing the system to adapt to change are needed.

### SUMMARY

Certain aspects provide an apparatus that comprises a context module to receive data from one or more input sources, to sample the data, and to determine a context of the data. The apparatus includes an attention module to receive samples of the data from the context module and determine whether the samples of the data contain information for processing. One or more specialized processing modules are used to generate processed data from the data based on a determination by the attention module to process the data and to send the processed data to the context module. The apparatus includes a decision module to receive the context of the data and the processed data from the context module and determine what actions should be executed based on the context of the data and the processed data. One or more action handlers are used to execute actions in response to instructions received from the decision module.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example Attention Assisted AI Architecture (A4 architecture).

FIG. 2 depicts an example implementation of the A4 architecture.

FIG. 3 depicts examples of feedback loops within the A4 architecture.

FIG. 4 depicts a flow diagram of a method for executing efficient use of computational resources.

FIG. 5 depicts an example processing system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments described herein are directed to an Attention Assisted AI Architecture (A4 architecture) for performing AI inferences that utilizes attention and specialized processing to implement AI solutions and enable AI models to run faster with fewer computational resources in a flexible manner. The A4 architecture includes a context module that receives input data from various data sources and determines a context for the input data. The A4 architecture uses an attention module to sample the input data and determine from the samples whether the data contains information for specialized processing. The AI architecture uses specialized processing modules to process the data identified as containing information for specialized processing by the attention module. The A4 architecture includes a decision module that decides what actions should be executed based on the context of the input data and the processed data output from the specialized processing modules. The A4 architecture uses action handlers to execute the actions output from the decision module.

Use of the content module to determine the context of the input data, the attention module to filter information from the input, and the specialized processing modules that provide specialized processing that enables the A4 architecture to provide a flexible approach to processing data that is not used by other AI systems.

The AI systems and methods described in U.S. Publication No. 2021/0142143A1 (143) are directed at providing AI solutions from context, artificial emotions, and predictive polynomials. While the 143 systems and methods share some terminology with the A4 architecture, such as context filtering and data filtering, the goals and implementations of the 143 systems and methods are different from the A4 architecture. The 143 systems and methods attempt to take a step towards strong AI (e.g., AI with self-awareness and self-reasoning) by developing a system with goals and “emotions.” The emotions are signals to continue to do something, change something, or stop something in pursuit of something else. The 143 systems and methods also respond to events to help achieve a goal. By contrast, the A4 architecture is configured to efficiently use and deploy AI models and computer systems in the specialized processing modules, which allows the AI models and computer systems to dynamically change over time without use of “emotions” or internal goals. Unlike the 143 systems and methods, the A4 architecture is not directed at making a “semi-strong” AI system, such as a system that can self-program and self-modify.

The global workspace theory (GWT) model replicates consciousness in data processing. The GWT model provides multiple subconscious processes that run in parallel using short term memory. However, in GWT model, the subconscious processes are unconscious and “unregulated.” By contrast, the A4 architecture processes are selectively used and controlled by the context module. Additionally, in GWT model, the unconscious processes are executed before the conscious processes. By contrast, in the A4 architecture, the information is evaluated by the attention module that uses attention as an awareness mechanism, then the information is optionally processed by a specialized processing module that further refines what the overall system is intended to achieve.

The methods and systems described in WO2020108303A1 (303) are directed to heterogeneous computing-based task processing. The 303 methods and systems break down a single AI task into multiple sub-tasks. By contrast, the A4 architecture is not a task processing method. The A4 architecture is directed to an efficient use of and interface with “tasks” regardless of how tasks are executed. The A4 architecture identifies and processes data identified as important by the attention module and executes actions based on the results of the processed data output from the specialized processing modules. The A4 architecture is not concerned with breaking the AI “tasks” into subtasks and separately processing the sub-tasks. Specialized processing performed by a specialized processing module is regarded as a single AI task (e.g., not a sub-task) and the A4 architecture interfaces with these tasks. The 303 method and system also does not account for the use of attention and selective processing as performed by A4 architecture.

Certain aspects of the A4 architecture described herein provides a technical solution to the above described technical problems with traditional methods and systems of specialized processing. The A4 architecture provides several novel innovations and advantages over other approaches to AI processing.

First, the A4 architecture has the ability to shift the focus of its attention, which allows the A4 architecture to remain effective in dynamic environments. The flexibility to integrate new specialized processing modules enables the A4 architecture to update capabilities, stay relevant, and efficient. This adaptability is a significant advantage over more rigid traditional techniques that may become obsolete or less efficient as conditions change.

Second, the A4 architecture is able to modify the decision-making process in real-time or near-real time. As a result, the A4 architecture is able to handle data under varying conditions and requirements. This dynamism is particularly beneficial in scenarios where processes or environments evolve unpredictably. The flexibility to integrate new action handlers enables the A4 architecture to be updated to “learn” or adapt to new actions. As the environment changes, the A4 architecture decisions and actions can change to reflect the changing environments.

Third, by concentrating on pertinent information, the A4 architecture conserves computational resources, such as CPU, memory, and power. This is increasingly important where data volume is increasing and processing power is increasingly becoming more valuable. The selective processing of the A4 architecture reduces the strain on memory and processing power, leading to a cost savings and increased efficiency. Selective processing is especially beneficial in applications where resources are limited, such as in embedded systems, mobile devices, and on-premises deployments.

Fourth, the A4 architecture employs specialized processing modules to focus on relevant information, which can significantly accelerate the performance of the A4 architecture by avoiding the overhead of processing extraneous data. The A4 architecture can optimize or prioritize the data processing and actions based on the specialized processing modules and on the available compute resources. Speed is often important in many applications, such as real-time data analytics, where quick decision-making can be vital.

Finally, the A4 architecture prioritizes adaptability, dynamic decision-making, resource efficiency, and speed, making the A4 architecture a highly versatile and effective solution in various applications. The A4 architecture is able to adjust to changing conditions and focus on particular data points.

### Example High-level Implementation of the Attention Assisted Ai Architecture

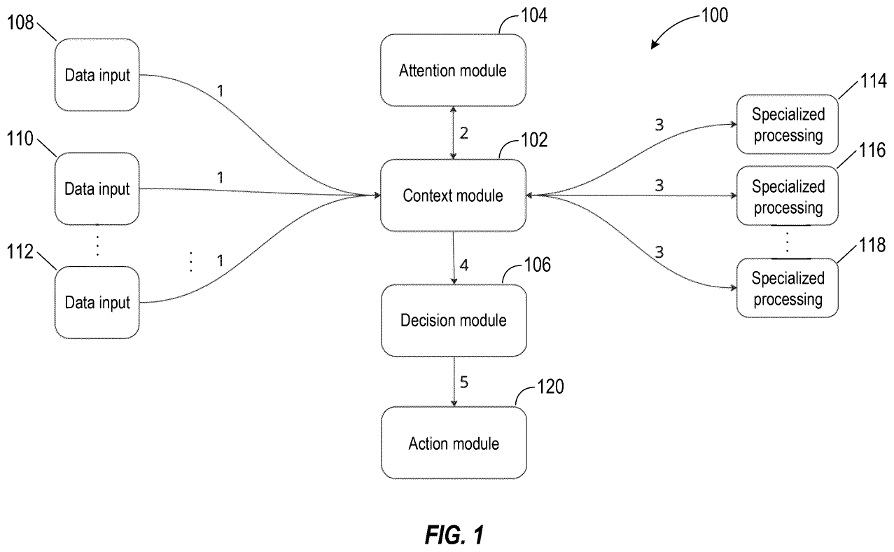

FIG. 1 depicts an example high-level implementation of an Attention Assisted AI Architecture (A4 architecture) 100. In this example, the A4 architecture 100 includes a context module 102, an attention module 104, a decision module 106, and an action module 120. The A4 architecture 100 includes specialized processing modules, such as specialized processing modules 114, 116, and 118. Data input, 110, and 112 are composed of data produced by various data sources. In FIG. 1, directional arrows represent the flow of data into and between modules of the A4 architecture. The directional arrows are numbered 1 through 5 to indicate the step-by-step sequence of operations performed by the modules.

The data input 108, 110, and 112 can be textual data, images, streaming data, or numerical data obtained from various data sources. The various data sources may be transmitting the same type of data. Alternatively, the various data sources may be transmitting different types of data. The A4 architecture 100 can handle input data from multiple sources and different data types. In various embodiments, input data is not limited to any particular formats. The input data may be homogeneous or heterogeneous. For example, the data may come in batches while other sources send continuous streams of data. For example, the data input 108, 110, and 112 can be streaming digital images produced by a number of corresponding cameras. Alternatively, the data input 108, 110, and 112 can be streaming audio data produced by a number of corresponding microphones. Alternatively, the data input 108, 110, and 112 can be textual data produced by any of various textual data sources, such as text messaging applications, email servers, or word processors.

As shown in FIG. 1, the data input 108, 110, and 112 is sent to the context module 102. The context module 102 determines the context of the data. For example, if the data input 108, 110, and 112 is textual data, the context module 102 determines what type of textual data is received. For example, the type of textual data could be text messages, email messages, or more extensive textual data from a complex legal document, such as a contract. Alternatively, if the data input 108, 110, and 112 is a series of images, the context module 102 determines the context, or content, of the images. The data input 108, 110, and 112 can be data generated by various types of sensor, such as temperature, pressure, or motion sensors. The context module 102 may read a sample of the input data and send the sampled data to the attention module 104.

The attention module 104 receives the sampled data to determine whether the input data contains information that should be further processed by one or more of the specialized processing modules 114, 116, or 118. For example, suppose the input data is composed of text messages. The context module 102 sends a sample of text messages to the attention module 104. The attention module 104 contains logic, or can be an AI model, that may determine the text messages should not be further processed by the specialized processing modules 114, 116, and 118. In some embodiments, this AI model could be a natural language processing (NLP) model, a rule-based model, or a trainable model, e.g., a large language model which may be single or multi-modal. On the other hand, suppose the input data is composed of textual data from a legal document or a scientific paper. The context module 102 sends samples, or chunks of text, of the textual data to the attention module 104. In this example, the attention module 104 may determine that the textual data contains subject matter that should be handled by the specialized processing modules 114, 116, and 118. The attention module 104 sends results to the context module 102. Unlike a mixture of experts approach, the context module 102 decides the appropriate specialized processing module or modules to forward the data to for further processing in response to the results received from the attention module 104. The context module 102 may also determine that no further processing is necessary, and refrain from sending any data for further analysis or processing. Conversely, an unexpected input to the attention module 104 can be used as a trigger for anomaly detection. In some embodiments, anomalous or otherwise unexpected input as identified by the attention module 104 may be assigned higher processing bandwidth, priority, or be assigned specific tags or attributes by the context module 102 to affect downstream analysis or processing.

The specialized processing modules 114, 116, and 118 are comprised of specialized processing algorithms. In some embodiments, specialized processing modules 114, 116, and 118 may be machine learning models (ML), such as regression models or clustering models. Some embodiments may utilize other specialized processing modules which can include but are not limited to different types of software algorithms, ML models, or AI models, such as generalized neural networks (NNs), convolutional NNs, recurrent NNs, or a combination of different types of NNs. Still other specialized processing modules can include large language models (LLMs), generative AI models, transformer models, and natural language processing (NLP) models. Unlike traditional models and algorithms that only have access to the data used to train the models on or is contained in local storage, one or more of the specialized processing modules 114, 116, and 118 may have internet access to dynamically access and retrieve additional information or data for use in the processing of the data input 108, 110, and 112. By being able to dynamically access the internet for data, the specialized processing modules are able to get data that is more recent (think recent events or breaking news that could affect stuff like financial decisions) or obtain data the specialized processing modules do not have locally.

In some embodiments, the additional information retrieved from the internet is used for retrieval augmented generation (RAG). One or more of the specialized processing modules 114, 116, and 118 can be processing algorithms that are not considered ML or AI. One or more of the specialized processing modules 114, 116, and 118 may reside on the same computing device as the rest of the system, or may reside in physical, logical, or network-separated distributed compute or processing devices. In some embodiments, the specialized processing modules 114, 116, and 118 may also include a human in the loop. In some embodiments, the human in the loop can be implemented as described in U.S. Application No. 63/607,040 filed Dec. 6, 2023.

After the context of one or more of the data input 108, 110, and 112 has been determined by the context module 102 and the data has been processed by one or more of the specialized processing modules 114, 116, and 118, the context module 102 sends the context of the data to the decision module 106. In other words, the context module 102 understands the data, identifies the data, or can make a determination as to what information is contained in the data. The decision module 106 determines what actions, if any, should be taken with the processed data based on the context of the data received from the context module 102. The decision module 106 sends the data and instructions for actions to be taken to the action module 120, which executes the actions in accordance with the instructions from the decision module 106. For example, suppose the context module 102 has determined that the data corresponds to cars, such as through images and vibration detection, and passes this information along with the data to the decision module 106. The decision model 106 is aware that there are not supposed to be cars passing through the area being monitored. In this example, the decision module 106 makes the decision to generate an alert. This decision gets passed to the action handlers which execute the alerting operations.

One aspect of the A4 architecture 100 is the ability of the attention module 104 to determine the relevant information without having to rely on queues, interrupts, or similar traditional event models or handling systems. Another aspect of the A4 architecture is the ability to handle multiple data inputs, using specialized processing for further analysis of the data, and the ability to change the desired actions of the A4 architecture 100 independently from the output of the attention module 104.

In some implementations, certain modules may be distinct AI agents, or instances of the same AI agent, prompted as appropriate. Some implementations may use agentic AI, pretrained and/or custom-trained or fine-tuned for one or more tasks. In some implementations, one or more AI agents (e.g., AI agents that instantiate or serve as an attention module, a context module, and/or a decision module) coordinate, activate, deactivate, update, prompt, fine-tune, or otherwise modify other AI agents (e.g., AI agents that instantiate or serve as specialized processing modules).

Aspects of the A4 architecture 100 described herein provide a qualitative improvement over current processing methods by enabling the attention mechanisms to control and optimize the data acquisition, flow, and processing. Furthermore, A4 architecture 100 enables AI modules integrated into a traditional software platform to run much more efficiently as specialized processing modules 114, 116, and 118. The A4 architecture allows AI modules to run faster in certain situations and allows for dynamically applying updates and changes.

### Example Implementation of the Attention Assisted AI Architecture

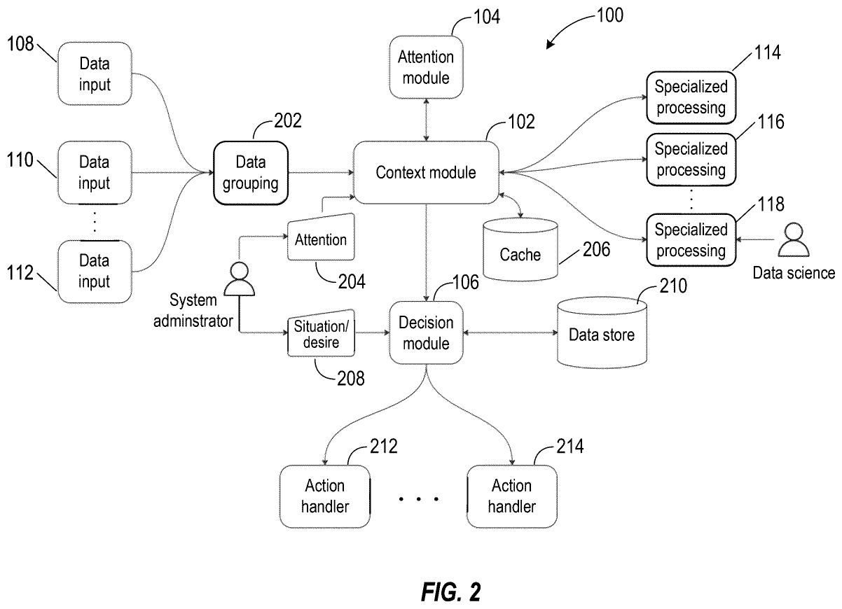

FIG. 2 depicts an example implementation of the A4 architecture 100 expanded to include a data grouping module 202, an attention input 204, a situation/desire input 208, a cache 206, a data store 210, and a number of separate action handlers, such as action handlers 212 and 214.

In the example of FIG. 2, the data grouping module 202 groups (e.g., using a multi-model neural network), fuses (e.g., sensor fusion or another aggregation of data inputs), or enriches (e.g., by means of RAG, a human-in-the-loop mechanism, an additional foundation model, or other information source) the data input 108, 110, and 112 before the data is input to the context module 102. The data grouping module 202 can execute processes such as sensor fusion, generation, or alignment of common data representations across sensor or input modalities, filtering or compression of information. Sensor fusion is combining inputs from more than one sensor into a single source of information. For example, the speed reading from a GPS module can combined with a speed determined by a physical speedometer to obtain a more accurate reading of the speed of an object, such as an automobile. In another embodiment, the data grouping module 202 can lower the bitrate to reduce the amount of data received. In some implements, the data grouping module 202 may utilize algorithms and or hardware developed for on-demand computing, branch prediction, power gating, etc. In another embodiment, the various sources of the input data can be updated and changed dynamically with sources being added, removed, or changed without having to change the A4 architecture 100.

The A4 architecture 100 includes the attention input 204 that contains instructions with regard to the type of content the attention module 104 should use to evaluate the sampled data received from the context module 102. The attention input 204 can be provided by a systems administrator or by another program or algorithm that utilizes the specialized processing modules for data processing. The context module 102 sends the sampled data and the attention input 204 to the attention module 104.

The attention module 104 may determine whether the data received by the context module 102 matches, resembles, or corresponds to the attention input 204. The attention module 104 is designed to have a high false positive rate and a low false negative rate. The attention module 104 performs a high-level or general scan of the data and identifies pieces of data for further investigation. For example, if the A4 architecture 100 is being used to search for dogs in images and the attention module 104 determines that an animal in the photograph may be a dog, then the attention module 104 may identify the photograph as being in need of further investigation. Note that the attention module 104 does not confirm that that photograph includes a dog. One or more of the specialized processing modules 114, 116, and 118 performs the process of definitively determining if the photograph includes a dog.

In some implementations, the attention module 104 may involve anomaly detection or it may be a network that is more simple or general than the specialized processing modules. In one embodiment, the attention module 104 can be a generative AI foundation model such as a multi-modal LLM. In many implementations, the importance of the high-level scan is to determine if a more detailed analysis of the information is needed. In some embodiments, the rate at which the attention module 104 is used can be varied independently of the rate at which the input data is received to further reduce processing time and usage of resources. In some embodiments, selected data or inputs are passed to the attention module 104, the rate at which data is sent to the attention module 104 is independent of the rate at which data is sent to the specialized processing modules 114, 116, and 118. In some implementations, the buffered inputs in the cache 206 can be used for specialized processing 114, 116, and 118. In some implementations, context of the information can be used over longer periods of time using neural network architectures, such as LSTM, GRU, or transformers, to determine which data is sent to the specialized processing modules. In one embodiment, data input 108 is a high-resolution video stream. In this embodiment, the context module 102 may process this stream at a lower resolution than it is used to store the stream in the data store 210 or cache 206. In this embodiment, upon a signal from the attention module 104 the specialized processing module 114 may use high-resolution data stored in the cache 206 to process input data that was collected in the past. In some implementations, the cache 206 is implemented as a buffer.

The output of the attention module 104 is information that notifies the context module 102 of how well the data matches the attention input 204, thus directing the attention of the A4 architecture to further processing of the input data. Based on the results output from the attention module 104, the context module 102 can optionally make use of the specialized processing modules 114, 116, and 118 if there is something that necessitates further processing and there is a suitable specialized processing module to perform the processing. For example, a result can be a JSON response with a field for an object and a percent confidence in identifying the object. The results can be text or another medium. In other words, the attention module 104 determines if there is any information contained in the input data that is worth processing. The specialized processing modules 114, 116, and 118 can determine with higher accuracy what it is and any infer any further information. For example, a specialized processing module may confirm that the image contains a dog, identify the breed of the dog, and guess at the emotional state of the dog.

The specialized processing modules 114, 116, and 118 can be run in parallel, which increases the speed of the A4 architecture 100. In some embodiments, the attention module 104 and the context module 102 may be implemented as a single integrated module and may share connectivity to other modules and data stores in the system.

In one embodiment, the rate at which the specialized processing modules 114, 116, and 118 are used is varied independently of the rate of the input data and independent of the rate of the attention module 104. In another embodiment, the specialized processing modules can be added, updated, and removed dynamically. In this situation, the context module 102 keeps track of each specialized processing module and determines which modules are available to use.

In another embodiment, one of the specialized processing modules 114, 116, or 118 functions as a default module which handles any inputs for further processing from the context module 102 that other specialized processing modules cannot handle or are not configured to recognize. The default module can be a default general purpose specialized processing module. For example, the default module can be a multi-modal foundation model that is generally good at a wide range of tasks.

In the example of FIG. 2, the A4 architecture 100 includes a cache 206 that allows the specialized processing modules 114, 116, and 118 access to previously recorded data to enrich the current data. In one embodiment, selected parts of the input data are sent to the specialized processing module, thereby significantly reducing the amount of data being processed.

The A4 architecture 100 includes a situation/desire module 208 that receives as input a desired outcome which is used to moderate how the data output from the specialized processing modules 114, 116, and 118 is to be used by the decision module 106. The situation/desire module 208 moderates the outcome of processing the decision module 106 can take into consideration. The ideal outcome can be input to the situation/desire module 208 by a systems administrator or by a process or algorithm and updated dynamically. For example, a desire can be a state that the system is trying to achieve, such as “I want to receive an alert every time a car crosses this bridge” to more complex and abstract desires can be “This factory should run safely”. The decision module 106 uses the desire to decide what, if any, action to take. The desire is the goal or the purpose of the overall information processing performed by the A4 architecture 100, which informs how the A4 architecture 100 is expected to respond to situations. This enables the A4 architecture 100 to change how to respond without changing any of the upstream inputs to the decision module 106. The desired outcome input to the situation/desire module 208 may contain correct ranges for control variables. In one system implementation, based on firefighting, the inputs to the attention module 104 contain information about fires, while the inputs to the situation/desire module 208 contain information about prioritizing human life over animal life and prioritizing animal life over inanimate items thereby creating a prioritized hierarchy that informs the decision module 106 as decision module 106 sends specific actions to be executed by the action handlers 212 and 214.

The A4 architecture includes a data store 210 that provides long-term data storage for the decision module 106. The data store 210 allows the decision module 106 to store previous data use previously stored data for current decision making.

In another embodiment, the context module 102 contains a filtering mechanism to optimize the decision module 106 from being overloaded with the outputs of the specialized processing modules 114, 116, and 118. The data and processed data output from the specialized processing modules 114, 116, and 118 is sent by the context module 102 to the decision module 106 if the data contains information that passes the filtering mechanism. If the data does not pass the filtering mechanism, e.g., contains no information of interest, the context module 102 does not pass the data to the decision module 106. In one embodiment, the decision module 106 can make use of AI models, or even be an AI model, to further enhance its decision making capabilities.

The action handlers 212 and 214 are modules that can take actions, such as send a notification or control commands sent to equipment. In one embodiment, an action handler can be configured to send an alert email describing a condition detected by one of the specialized processing modules 114, 116, or 118. In another embodiment, an action handler may be configured to control equipment in order to aim and turn on a fire hose to extinguish fires detected by one of the specialized processing modules 114, 116, or 118. This configuration decouples the actions from the decisions of the decision module, which enables increased flexibility and speed. In one embodiment, each action handler is a separate entity which allows several actions to happen simultaneously. In another embodiment, action handlers can be added, removed, or updated dynamically, allowing the A4 architecture to take new actions over time.

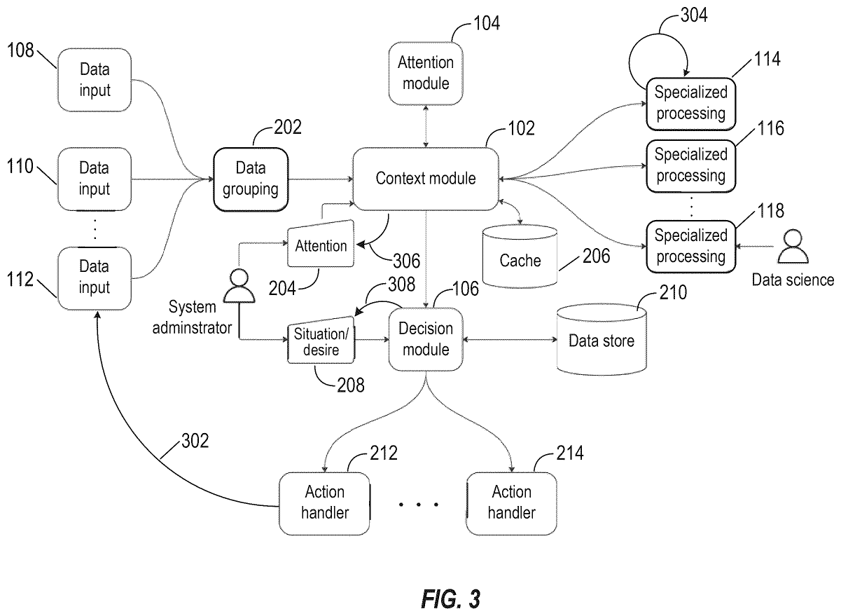

FIG. 3 depicts examples of feedback loops that may be present within some embodiments of the A4 architecture. A feedback loop is created by sending data output from any of the action handlers back into the context module 102 for further processing. The output from any one or more of the action handlers can be used as input data to the A4 architecture 100. For example, directional arrow 302 represents data that is output form the action handler 212, which becomes data input 112. In one embodiment, the action handler makes a physical change and the results of that change become new inputs themselves. For example, the action handler 212 may turn on a hose; the rate of flow from that hose would then be fed into the system as an input 112, the new input also updates 306 the attention input 204, which takes into account where the water is being directed by the hose. The specialized processing modules 114, 116, and 118 can also use self-feedback loops 304 to update or re-train the processing module on any of the data available within the system at any time.

### Example Method for Executing Efficient Use of Computational Resources

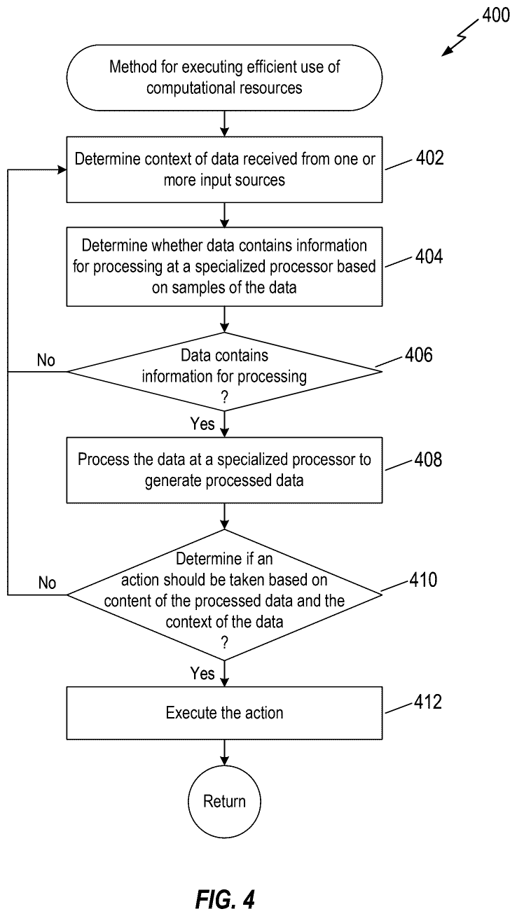

FIG. 4 depicts a flow diagram of a method 400 for executing efficient use of computational resources.

In block 402, the context of data received from one or more input sources is determined as described above with reference to FIG. 1. For example, the context of the data may be video data or sound data.

In block 404, a determination is made as to whether the data obtain in block 402 contains information processing based on the content of samples of the data as described above with reference to FIG. 1. For example, the content of the data may be the content of the video data, such a video stream contains an images of a person, an image of an animal, or an image of a particular object.

In block 406, if the data contains information for specialized processing, control flows to block 408 as described above with reference to FIG. 1.

In block 408, specialized processing is executed on the data to generate processed data as described above with reference to FIG. 1. For example, the specialized processing may be use of an AI model to identify the person, the animal, or the object contained in the video data.

In block 410, a determination is made whether to execute an action based on the processed data and the context of the data as described above with reference to FIG. 1. If it is determined that an action should be taken, then control flows to block 412. If it is determined that no action should be taken, then control flows to block 402. For example, the action may be an alert, such as generating a sound at a speaker, executing an automated mechanical process, and/or sending an alert message to appropriate personnel.

In block 412, the action determined in block 410 is executed as described above with reference to FIG. 1.

The architecture 100 and the method 400 provide a technological solution to the technical problems associated with traditional methods and systems of specialized processing of data described above by determining whether input data received from one or more sources contains information for specialized processing from samples of the input data. Moreover, the architecture 100 and the method 400 execute specialized processing in response to a determination that specialized processing is needed and are able to determine appropriate actions in response to processed data output from the specialized processing and initiate appropriate actions.

### Example Processing System for Efficient Use of Computational Resources

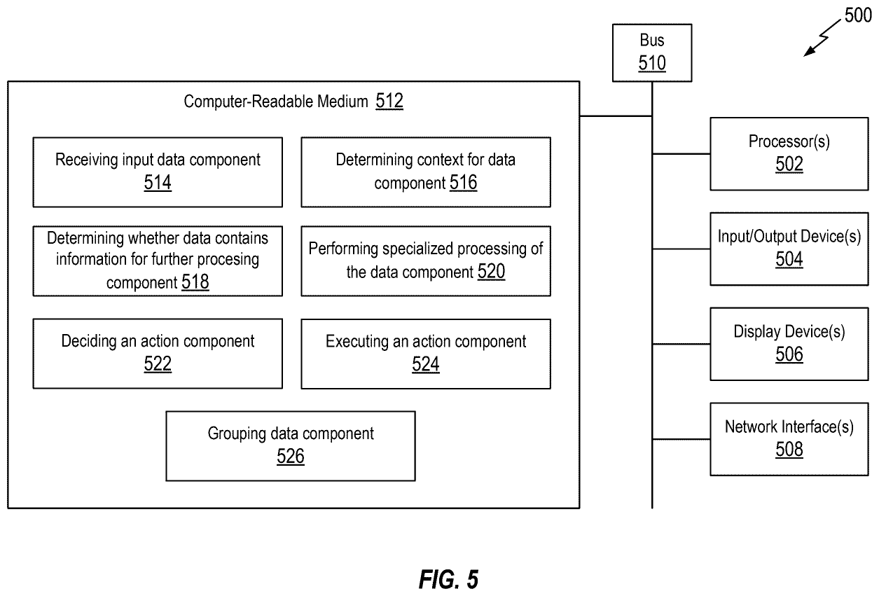

FIG. 5 depicts an example processing system 500 configured to perform various aspects described herein, including, for example, a method for efficient use of computational resources as described above with respect to FIG. 4.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 502, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes a receiving input data component 514, determining context for data component 516, determine whether data contains information for further processing component 518, performing specialized processing of the data component 520, deciding an action component 522, executing an action component 524, and grouping data component 526.

In certain embodiments, the computer-readable medium 512 includes a receiving input data component 514 that is configured to receive input data from one or more data inputs as described above with reference to FIGS. 1 and 4.

In certain embodiments, the computer-readable medium 512 includes a determining context for data component 516 that is configured to determine context of the input data as described above with reference to FIGS. 1 and 4.

In certain embodiments, the computer-readable medium 512 includes a determining whether the data contains information for further processing component 518 that is configured to determine whether the data contains information for further processing by specialized processors as described above with reference to FIGS. 1 and 4.

In certain embodiments, the computer-readable medium 512 includes a performing specialized processing of data component 520 that is configured to perform specialized processing of the data as described above with reference to FIGS. 1 and 4.

In certain embodiments, the computer-readable medium 512 includes a deciding an action component 522 that is configured to decide an action to be taken based on the processed data and the context of the data as described above with reference to FIGS. 1 and 4.

In certain embodiments, the computer-readable medium 512 includes a grouping data component 524 that is configured to group incoming data together as described above with reference to FIGS. 1 and 4.

In certain embodiments, the computer-readable medium 512 includes a grouping data component 526 that is configured to execute the action as described above with reference to FIGS. 1 and 4.

Note that FIG. 5 is just one example of a processing system consistent with aspects described herein, and other processing systems having additional, alternative, or fewer components are possible consistent with this disclosure.

### Example Practical Application of Processing System for Processing Video Streams

Processing multiple video streams from multiple cameras with the same frame rate, resolution, and level of analysis is a challenging problem. Some streams may have higher prioritized than others depending on the task and situation context (known threats, date and time, operation schedule, previous detections/alerts, etc.), including the type of information present in the streams, such as motion, suspicious activity, items of interest or anomalies detected, and camera tampering, just to name a few. Some streams may require a special type of video processing. For example, license-plate or face detection, camera focusing or digital magnification of specific areas of interest, application of specialized and/or compute-intensive AI/ML models, alert generation, and reporting, require specialized processing video processing.

In certain aspects, the processing system 500 may be used to control and monitor a closed-circuit television (CCTV) system, which solves the technical problem of processing multiple video streams. The CCTV system includes one or more cameras, one or more peripheral compute nodes, and a central computational device and console where streams of video data output from the one or more cameras are processed. For example, the processing system 500 may be located in a central computing device such as a server. The CCTV cameras are attached as data inputs of the network 508. As streams of video data come from the cameras, the receiving input data component 514 collects the incoming video data (e.g., CCTV footage and correlating camera location).

In certain aspects, the grouping component 526 groups camera footage based on the camera location and may compresses and/or downsample the footage from less important areas to more efficiently use computational and storage resources of the processing system 500.

In certain aspects, the determining context for data component 516 decides which groups of data should receive further processing at specialized processors, which efficiently uses the processors 502 by only processing certain streams of video data for further analysis. Grouping streams of video data can based on a multitude of factors. For example, grouping may be based on whether the footage contains an object of interest, such as a person or a vehicle. Grouping may also be based on whether there is an anomaly in the footage. If the video data is determined to need further specialized processing at a specialized processing, then the component 520 can be used to further process and analyze the data. For example, specialized processing may include facial recognition for video data containing a person or reading a license plate and vehicle identification. If the video data was determined to have an anomaly, then video data may be analyzed for the type of anomaly (focus shift, obstruction, FOV shift, etc.) and the degree to which it has changed.

In certain aspects, the deciding action component 522 may determine if any action is executed based on the analyzed video data. For example, the deciding action component 522 may decide that a person has entered an area the person is not authorized to be in and alert security personnel. Suppose a camera has shifted out of focus and needs to be refocused. In this example, the executing an action component 524 executes appropriate steps to focus the camera. For example, the executing an action component 524 may execute automated instructions that refocuses the camera. Alternatively, the executing an action component 524 may alert maintenance personnel to manually refocus the camera. In another example, the executing an action component 524 may alert security personnel to an unauthorized entry or send a signal directly to the security team's communication systems via an output device 504. In another example, the executing an action component 524 may display an alert status on a display device 506 and/or show a view of a camera focused on the unauthorized person.

### Example Clauses

Implementation examples are described in the following numbered clauses:

Clause 1: A computer-implemented method, comprising: determining a context of data received from an input source; determining whether the data contains information for processing at a specialized processor based on content of a sample of the data; processing the data at the specialized processor to generate processed data in response to the data containing information for processing; and executing an action based on content of the processed data and context of the data.

Clause 2: The method of Clause 1, further comprises grouping data received from one or more input sources.

Clause 3: The method of any of Clauses 1-2, further comprising grouping data received from one or more input sources.

Clause 4: The method of any of Clauses 1-3, wherein determining whether the data contains information for processing at the specialized processing modules comprises: sampling the data to obtain sampled data; and determining whether the sampled data contains information for processing.

Clause 5: The method of any of Clauses 1-4, further comprising using a self-feedback loop to retrain the specialized processor.

Clause 6: The method of any of Clauses 1-5, wherein processing the data at the specialized processor to generate processed data comprises executing facial recognition.

Clause 7: The method of any of Clauses 1-6, wherein processing the data at the specialized processor to generate processed data comprises reading a license plate.

Clause 8: The method of any of Clauses 1-7, wherein processing the data at the specialized processor to generate processed data comprises identifying a vehicle.

Clause 9: The method of any of Clauses 1-8, wherein processing the data at the specialized processor to generate processed data comprises identifying a sound.

Clause 10: A processing system, comprising: a memory comprising computer-executable instructions; and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

Clause 14: An apparatus, comprising: a context module to receive data from one or more input sources, to sample the data, and to determine a context of the data; an attention module to receive samples of the data from the context module and determine whether the samples of the data contain information for processing; one or more specialized processing modules to generate processed data from the data based on a determination by the attention module to process the data and to send the processed data to the context module; a decision module to receive the context of the data and the processed data from the context module and determine actions to be executed based on the context of the data and the processed data; and one or more action handlers to execute the actions in response to instructions received from the decision module.

Clause 15: The apparatus of Clause 14, further comprising a data grouping module to group, fuse, or enrich the data received from the one or more input sources before the data is input to the context module.

Clause 16: The apparatus of any of Clauses 14-15, further comprising an attention input that contains instructions with regard to content the attention module uses to evaluate the samples of the data received from the context module.

Clause 17: The apparatus of any of Clauses 14-16, wherein the attention module includes a first AI module to determine whether the data contains information for processing by the specialized processing modules.

Clause 18: The apparatus of any of Clauses 14-17, wherein the decision module includes a second AI module to determine an action in response to the context of the data and the processed data received from the context module.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, acc, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
a context module to receive data from one or more input sources, to sample the data, and to determine a context of the data;
an attention module to receive samples of the data from the context module and determine whether the samples of the data contain information for processing;
one or more specialized processing modules to generate processed data from the data based on a determination by the attention module to process the data and to send the processed data to the context module;
a decision module to receive the context of the data and the processed data from the context module and determine actions to be executed based on the context of the data and the processed data; and
one or more action handlers to execute the actions in response to instructions received from the decision module.

2. The apparatus of claim 1, further comprising a data grouping module to group, fuse, or enrich the data received from the one or more input sources before the data is input to the context module.

3. The apparatus of claim 2, wherein the data grouping module is configured to lower a bitrate to reduce an amount of data received by the context module.

4. The apparatus of claim 1, further comprising an attention input that contains instructions with regard to content the attention module uses to evaluate the samples of the data received from the context module.

5. The apparatus of claim 1, wherein the attention module includes a first artificial intelligence (AI) module to determine whether the data contains information for processing by the specialized processing modules.

6. The apparatus of claim 5, wherein the decision module includes a second AI module to determine an action in response to the context of the data and the processed data received from the context module.

7. The apparatus of claim 1, further comprising a cache configured to allow the one or more specialized processing modules to access to previously recorded data.

8. The apparatus of claim 1, wherein a first rate at which the attention module is used varies independently of a second rate at which data is received by the attention module.

9. The apparatus of claim 1, wherein a first rate at which data is sent to the attention module is independent of a second rate at which data is sent to the specialized processing modules.

10. The apparatus of claim 1, further comprising a situation/desire module configured to receive as input a desired outcome, the desired outcome operable to moderate how data output from the specialized processing modules is to be used by the decision module.

11. The apparatus of claim 1, further comprising a data store configured to provide long-term data storage for the decision module.

12. The apparatus of claim 1, wherein:
the attention module, context module, and decision module are a plurality of first distinct AI agents,
the specialized processing modules are a plurality of second distinct AI agents, and
the first distinct AI agents are configured to coordinate, deactivate, update, prompt, fine-tune, or modify the second distinct AI agents.

13. A computer-implemented method, comprising:
determining a context of data received from an input source;
determining whether the data contains information for processing at a specialized processor based on content of a sample of the data;
processing the data at the specialized processor to generate processed data in response to the data containing information for processing; and
executing an action based on content of the processed data and context of the data.

14. The method of claim 13, further comprising grouping data received from one or more input sources.

15. The method of claim 13, wherein determining whether the data contains information for processing at the specialized processing modules comprises:
sampling the data to obtain sampled data; and
determining whether the sampled data contains information for processing.

16. The method of claim 13, further comprising using a self-feedback loop to retrain the specialized processor.

17. The method of claim 13, wherein processing the data at the specialized processor to generate processed data comprises executing facial recognition.

18. The method of claim 13, wherein processing the data at the specialized processor to generate processed data comprises reading a license plate.

19. The method of claim 13, wherein processing the data at the specialized processor to generate processed data comprises identifying a vehicle.

20. The method of claim 13, wherein processing the data at the specialized processor to generate processed data comprises identifying a sound.
